(19) United States
(12) Patent Application Publication
(10) Pub. No.: US 2024/0022131 A1
(43) Pub. Date: Jan. 18, 2024

(54) Lap Windings for Electric Machine with Series Connection on Outside Diameter

(71) Applicant: BorgWarner Inc., Auburn Hills, MI (US)

(72) Inventor: Kirk Neet, Noblesville, IN (US)

(21) Appl. No.: 18/351,926

(22) Filed: Jul. 13, 2023

Related U.S. Application Data
(60) Provisional application No. 63/388,893, filed on Jul. 13, 2022.

(51) Int. Cl. H02K 3/28

(52) U.S. Cl. CPC H02K 3/28

(57) ABSTRACT

An electric machine includes a stator core and a plurality of windings wound on the stator core. The plurality of windings include a first coil group arranged in a plurality of layers of the stator core and a second coil group arranged in the plurality of layers of the stator core. At least one connection conductor extends between the first coil group and the second coil group. The at least one connection conductor is provided in at least one extra-outer layer of the stator core.

### CROSS-REFERENCE TO RELATED APPLICATIONS

The present application claims the benefit of U.S. provisional application No. 63/388,893, filed Jul. 13, 2022, the entire contents of which are incorporated by reference herein.

### FIELD

The present disclosure relates to the field of electric machines, and more particularly, stator winding arrangements and connections for such winding arrangements.

### BACKGROUND

Electric machines are designed to meet specific operating requirements that depend at least in part on the intended application for the electric machine. Examples of design features that contribute to operating performance include stator size, rotor size, type and arrangement of the windings, and any of various other design parameters as will be recognized by those of ordinary skill in the art. All operating requirements for the electric machine must be met while also meeting certain space constraints that are also dependent upon the intended application for the electric machine. For automotive applications, space within the engine compartment is limited, and engineers must be concerned with the overall diameter and length of the electric machine. Accordingly, limiting the size of an electric machine without sacrificing performance features is a significant consideration when designing an electric machine.

Stators for electric machines include a core with a plurality of windings arranged on the core, each of the windings formed with a number of connected wires or other conductors. The conductors that form the windings are often segmented conductors (which may also be referred to herein as “hairpin” conductors), such as those disclosed in U.S. Pat. Nos. 7,622,843 and 7,348,705, the contents of which are incorporated herein by reference. Hairpin conductors include a pre-formed end loop (180° turn) with two straight legs extending from opposite sides of the end loop. The legs hairpin conductors are inserted into the stator core with the end loops on a crown end and the legs extending through the slots of a stator core. The leg ends extending from the connection end are then bend and connected together to form a desired winding configuration. As noted in U.S. Pat. No. 7,348,705, segmented conductors may be used to form both wave windings and lap windings.

Different connection challenges are encountered by designers depending on the winding features and the type of winding for an electric machine. For example, for a specific winding arrangement, it is often challenging to connect special connections between certain winding segments including those connections that extend between different layers, different paths, and/or those associated with different coils. When making such connections, care must be taken to maintain the desired operating requirements while also maintaining the winding within the desired size constraints.

In view of the forgoing, it would be desirable to provide an electric machine with special winding connections for lap windings. It would be advantageous if such winding connections were of limited size and length. It would also be desirable to make such connections without compromising the operating requirements of the electric machine.

While it would be desirable to provide an electric machine that provides one or more of the foregoing or other advantageous features as may be apparent to those reviewing this disclosure, the teachings disclosed herein extend to those embodiments which fall within the scope of any eventually appended claims, regardless of whether they accomplish one or more of the above-mentioned advantages.

### BRIEF DESCRIPTION OF THE DRAWINGS

FIG. 1 shows a schematic view of one phase of a winding arrangement formed from lap windings, the winding arrangement including, three phases, three parallel paths per phase, and six conductors per slot.

FIG. 2 shows an enlargement of slots 1-22 of the schematic arrangement of FIG. 1, the schematic illustrating the direction of conductor twist associated with each layer as well as the direction of outside diameter series connections between winding coils.

FIG. 3 shows a side view of an alternative embodiment of the outside series connections of FIG. 2.

FIG. 4 shows a top view of a weld pattern for the windings of FIG. 1, the windings having the alternative embodiment of the outside series connection of FIG. 3.

FIG. 5 shows a side view of a stator including the windings of FIG. 1 and the alternative embodiment of the outside series connection of FIG. 3.

FIG. 6 shows a side view of another alternative embodiment of the outside series connection of FIG. 2.

### SUMMARY

In at least one embodiment of the disclosure herein, an electric machine includes a stator core and a plurality of windings wound on the stator core. The plurality of windings include a first coil group arranged in a plurality of layers of the stator core and a second coil group arranged in the plurality of layers of the stator core. At least one connection conductor extends between the first coil group and the second coil group. The at least one connection conductor is provided in at least one extra-outer layer of the stator core.

In at least one embodiment of the disclosure herein, a stator includes a cylindrical core defined by an inner diameter and an outer diameter with a plurality of teeth extending radially inward to the inner diameter and slots formed between the teeth. A winding arrangement is formed by plurality of segmented conductors arranged in the slots of the core. The plurality of segmented conductors are positioned in layers within the slots and connected together on a connection end of the core that is opposite a crown end of the core. The layers of the core include an inner layer and an outer layer. The connected segmented conductors form at least one first coil and at least one second coil on the core. The segmented conductors extending from the outer layer are twisted in a first direction on the connection end of the core. At least one connection conductor extends from the outer layer and is bent to a position radially outward from the segmented conductors positioned in the outer layer of the core. The at least one connection conductor connects the at least one first coil to the at least one second coil on the core.

In at least one embodiment of the disclosure herein, an electric machine includes a plurality of lap windings positioned on a stator core. The plurality of lap windings include at least one first coil and at least one second coil. The at least one first coil is arranged between an inner conductor layer and an outer conductor layer of the stator core, the at least one first coil making multiple laps through slots of the stator core associated with a first pair of poles of the electric machine. The at least one second coil is also arranged between the inner conductor layer and the outer conductor layer of the stator core, the at least one second coil making multiple laps through slots of the stator core associated with a second pair of poles of the electric machine. At least one connecting conductor is positioned in an extra-outer layer of the stator core and connects the at least one first coil to the at least one second coil.

### DESCRIPTION

A stator having a winding arrangement with outside diameter series connections is disclosed herein. The winding arrangement is comprised of segmented conductors formed into lap windings and including special twists of certain wires along the outer diameter in order to provide series connections between different coils of the lap windings.

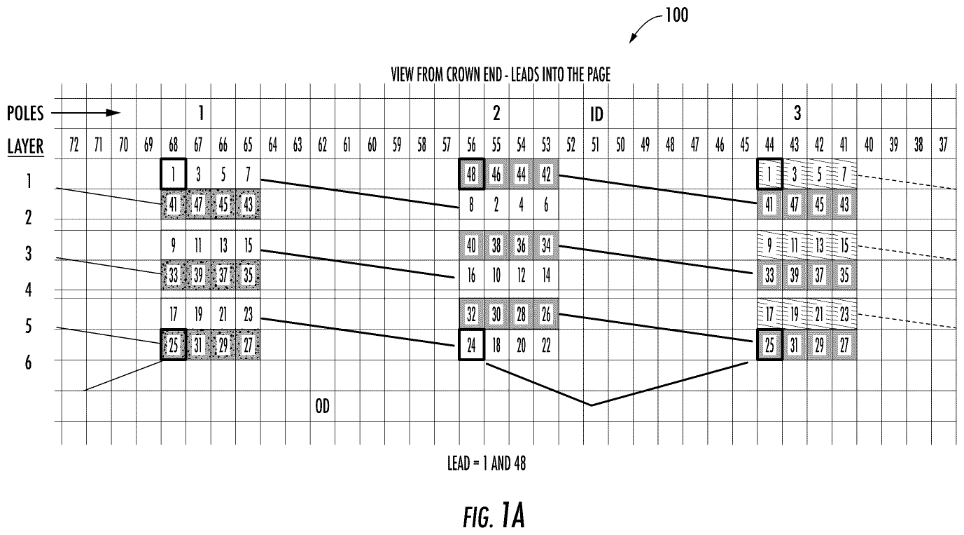

With reference to FIG. 1 a schematic of a winding arrangement 120 is shown viewed from a crown end of the stator with the leads extending into the page (i.e., in a direction away from the viewer). The winding arrangement 120 is formed of segmented conductors, each having a hairpin shape, wherein the legs of each segmented conductor are inserted into slots of a stator core. The legs of different conductors are typically arranged in a single-file manner within each slot, wherein each position in the slot is a “layer” of the slot. As shown in FIG. 1, layer 1 is the innermost layer of the slot (i.e., closest to the inner diameter of the core), and layer 6 is the outermost layer of the slot (i.e., closest to the outer diameter of the core). Once the legs of a segmented conductor are inserted into two slots of the core, the end loop portion of the segmented conductor is arranged on an insertion end of the stator core (i.e., the crown end), the legs extend through slots of the core, and the leg ends extend from the weld end of the stator core. The tabular illustration of FIG. 1 is shown viewed from the crown end, such that the ends of the segmented conductors extend into the page and are twisted to form lap windings.

The winding arrangement of FIG. 1 is defined by six poles, includes six conductors per slot (i.e., six layers of conductors in each slot), and includes three parallel paths per phase. Only one phase of the winding arrangement 120 is shown in FIG. 1, and it will be recognized that two additional phases are also included in the winding arrangement, but the additional phases are not shown for the sake of convenience and simplicity of the drawings.

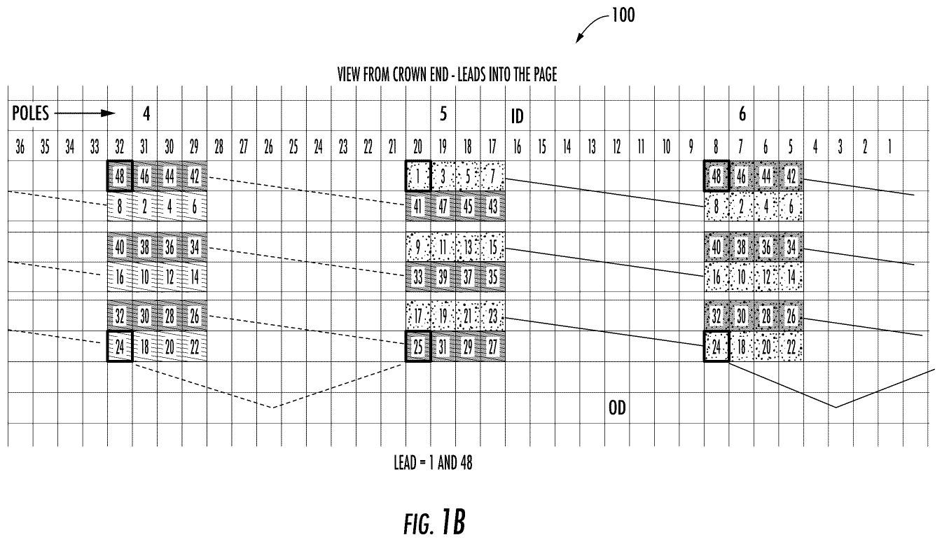

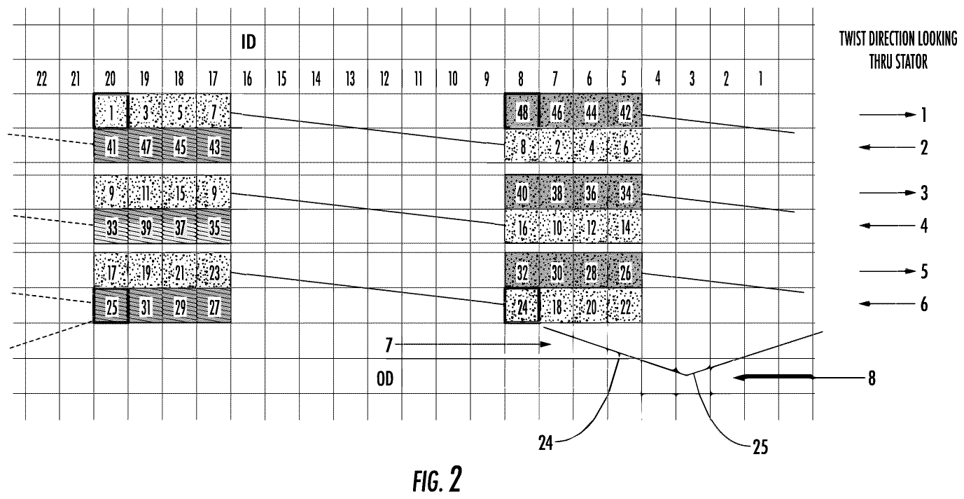

With continued reference to FIG. 1, each phase of the winding arrangement 120 includes three parallel paths. The three parallel paths are shown in FIG. 1 by a first path “A” (also referred to herein as the “A path,” and identified in FIGS. 1 and 2 by boxes with numbering and a background free of diagonal lines and stippling), a second path “B” (also referred to herein as the “B path,” and identified in FIGS. 1 and 2 by boxes with numbering and a background of diagonal lines), and a third path “C” (also referred to herein as the “C path,” and identified in FIGS. 1 and 2 by boxes with numbering and a background of stippling). Each of path A, path B, and path C includes forty-eight in-slot portions as noted in FIGS. 1 and 2 by boxes 1-48 for each of path A, path B and path C. Each of boxes 1-48 is associated with one conductor segment (which may be referred herein as simply a “segment,” “conductor,” or “leg”) positioned in a slot of the stator core.

Each path (A, B and C) of each phase of the winding defines a first coil group formed by first conductor segments 1-24 and a second coil group formed by second conductor segments 25-48. For each path (A, B and C) shown in FIGS. 1 and 2, the first coil group is denoted by the numbers 1-24 positioned in non-shaded boxes (i.e., A path non-shaded boxes 1-24 with no background, B path non-shaded boxes 1-24 with diagonal line backgrounds, and C path non-shaded boxes 1-24 with stippling backgrounds). Similarly, the second coil group for each path is denoted by the numbers 25-48 positioned in shaded boxes (i.e., A path shaded boxes 25-48 with no background, B path shaded boxes 25-48 with diagonal line backgrounds, and C path shaded boxes 25-48 with stippling backgrounds). As will be recognized from FIG. 1, the first coil group and the second coil group of each path overlap (i.e., share the same slots) in a middle set of slots that are associated with one of the poles of the winding 120. For example, for the A path, the first coil group (identified by boxes with numbers 1-24 and no background shading) is located in slots 53-56 and 65-68, while the second coil group (identified by boxes with numbers 25-48 and background shading) is located in slots 41-44 and 53-56. Therefore, for the A path, the first group of coils and the second group of coils overlap at slots 53-56. Stated differently, for path A, the first coil group is associated with poles 1 and 2, and the second coil group is associated with poles 2 and 3, such that the first and second coil groups overlap at pole 2.

With reference now to FIG. 2, the twist direction of the conductors is illustrated on the far right side of the diagram for each layer of the winding in order to further explain the nature of the end loops that provide the connections between the conductor segments (which end loops may alternatively be referred to herein as “end turns”). As shown in FIG. 2, the conductors in layers one, three and five are all twisted to the right, while the conductors in layers two, four and six are all twisted to the left (with the exception of certain series connection conductors in layer six, as described in further detail below). While FIG. 2 only shows conductors for the B path and C path, it will be recognized that the bend/twist direction is the same for each of the A path, B path and C path in each layer. Thus, the conductors in each layer are all bent/twisted in one direction and the conductors are bent/twisted in opposite directions in alternating layers (i.e., the conductors in layers 1, 3 and 5 for each of paths A, B and C are all bent in a first direction, and the conductors in layers 2, 4 and 6 for each of paths A, B and C are all bent in a second direction that is opposite the first direction). It will be recognized that this alternating bend/twist direction in alternating layers is true of the twist direction of the leg ends on the weld end as well as the bend/twist direction of the conductors exiting the slots on the crown end. Additionally, it will be recognized that the words “bend” and “twist” are used interchangeably herein to refer to manipulation of a conductor to move it to a desired position having a desired shape. Accordingly, the use of either of the words “bent” or “twisted” implies at least some bending and/or twisting of the conductor in the radial or circumferential directions in order to form the conductor into the desired shape.

With knowledge of the twist direction of the conductors in each layer, a complete path for the winding arrangement can be traced by moving one-by-one through each of boxes 1-48 within the path. For example, tracing the A path begins at box 1 of the A path of FIG. 1. Here, it can be seen that a lead (illustrated by a bold outlined box) extends outward at the weld end of the stator core at layer 1 of slot 68. Conductor 1 (i.e., the conductor leg arranged in layer 1 of slot 68) then extends from the weld end to the crown end of the core. At the crown end of the core, an end turn connects conductor 1 to conductor 2 (i.e., the conductor leg in layer 2 of slot 55). Because this end turn extends from slot 55 to slot 68, it will be recognized that this is a 13-pitch end turn (i.e., 68−55=13). Most of the end turns on the crown end have this same 13-pitch, with the exception of certain final lap end loops, as described in further detail below.

After the end turn, conductor 2 extends from the crown end back to the weld end of the stator core. On the weld end, the leg end of conductor 2 is twisted to the left (similar to all other conductors in layer 2) and welded or otherwise joined to the leg end of conductor 3, which is twisted to the right (similar to all other conductors in layer 1). Because conductor 2 is in slot 55, and because conductor 3 is in slot 67, it will be recognized that the resulting end turn between conductors 2 and 3 on the weld end of the stator core is a 12-pitch end turn (i.e., 67−55=12). All of the end turns on the weld end have this same 12-pitch, with the exception of some embodiments of the outer diameter series connections between conductors 24 and 25 of each path, as described in further detail below.

Continuing with tracing the A path in FIG. 1, conductor 3 extends through slot 19 of the stator core and returns the path to the crown end. At the crown end, another end loop connects conductor 3 to conductor 4. Because conductor 3 is in slot 67, and because conductor 4 is in slot 54, it will be recognized that the resulting end loop between conductors 3 and 4 on the crown end of the stator core is a 13-pitch end loop (i.e., 67−54=13).

The pattern described above continues until and an end loop connects conductor 7 to conductor 8. This end loop is a 9-pitch end loop because it connects the conductor in slot 65 with the conductor in slot 56 (i.e., 65−56=9). It will be recognized that conductors 1-8 thus form four laps of a coil in layers 1 and 2 of slots 65-68 and 53-56 (i.e., the conductors make four laps through poles 2 and 3 in layers 1 and 2 of FIG. 1). These four laps include a first lap formed by conductors 1 and 2, a second lap formed by conductors 3 and 4, a third lap formed by conductors 5 and 6, and a fourth lap formed by conductors 7 and 8. The 9-pitch end loop connecting conductors 7 and 8 provides the final lap end loop for conductors in a particular layer-pair (i.e., layer pair 1-2) that lap through the two poles (and may thus be referred to as a “final lap end loop”). Because this final lap end loop is only 9-pitch at the crown end, while the other end loops at the crown end for the layer pair are 13-pitch, the final lap end loop is considered to be a “short pitch” end loop (i.e., the final lap end loop has a shorter pitch than the standard end loops at the crown end). Following the final lap end loop, the winding path transitions to another layer-pair (i.e., layer pair 3-4) wherein more laps are formed, as described in the following paragraphs.

Continuing the trace of the A path from conductor 8 on the weld end of the stator, conductor 8 twists to the left (i.e., like the other conductors in layer 2). However, instead of continuing the previous pattern and connecting to a conductor in layer 1, conductor 8 instead connects to one of the conductors in layer 3. Specifically, conductor 8 is connected to conductor 9 of layer 3 at the weld end of the stator core. This loop between conductor 8 and conductor 9 is a standard 12-pitch end loop, similar to other end loops formed at the weld end of the stator core. Then, in a similar manner to that of conductors 1-8, conductors 9-16 form four more laps of a coil in layers 3 and 4 of slots 65-68 and 53-56. This pattern then copies for conductors 17-24, and four more laps of a coil are formed in layers 5 and 6 of slots 65-68 and 53-56, as shown in FIG. 1. As a result, it will be recognized that conductors 1-24 of the A path form three coils that are connected in series and arranged in poles 1 and 2 of the winding: conductors 1-8 form a first coil in layer pair 1-2; conductors 9-16 form a second coil in layer pair 3-4; and conductors 17-24 form a third coil in layer pair 5-6. These three coils collectively form a first coil group for the A path.

Next, at the weld end of the stator core, conductor 24 is connected to conductor 25. This connection, described in further detail below, is a series connection between the first coil group of the A path (i.e., conductors 1-24 as explained in the foregoing paragraph and illustrated in FIG. 1 by the clear boxes with no background lines or stippling) and a second coil group of the A path (i.e., conductors 25-48 illustrated by the shaded boxes with no background lines or stippling). A similar pattern to that of conductors 1-24 is then repeated with conductors 25-48 of the A path, and conductors 25-48 form twelve coil laps in slots 41-44 and 53-56. In particular, conductors 25-48 of the A path form three coils that are connected in series and arranged in poles 2 and 3 of the winding: conductors 25-32 form a first coil in layer pair 5-6; conductors 33-40 form a second coil in layer pair 3-4; and conductors 41-48 form a third coil in layer pair 1-2. These three coils collectively form the second coil group for the A path. Again, it will be recognized that the coils of the first coil group of the A path overlap with the coils of the second coil group of the A path at slots 53-56. In other words, the coils of the first coil group and the second coil group overlap at pole 2.

The connection between the first coil group and the second coil group of the A path is provided between conductors 24 and 25. This connection between conductors 24 and 25 is special connection formed in one or more extra-outer layers of the winding arrangement. In other words, the connection between the first coil group and the second coil group of the A path is formed radially outward from the outer layer of the winding, and this radially outward layer may be considered an extra-outer layer of the winding. In the embodiment of FIGS. 1 and 2, layer 6 is considered to be the outer layer, and the connection between the first coil group and the second coil group of the A path may be considered to reside at least in part in an extra-outer layer 7 at the outer diameter of the stator core. While layer 6 is considered to be the outer layer of the winding in the embodiment of FIGS. 1 and 2, it will be recognized that the outer layer may be a different numbered layer in other embodiments (e.g., if the winding is formed in eight layers, layer 8 may be the outer layer). This series connection between conductors 24 and 25 may be made in a number of different ways in one or more extra-outer layers. Exemplary embodiments of this connection are described in further detail below.

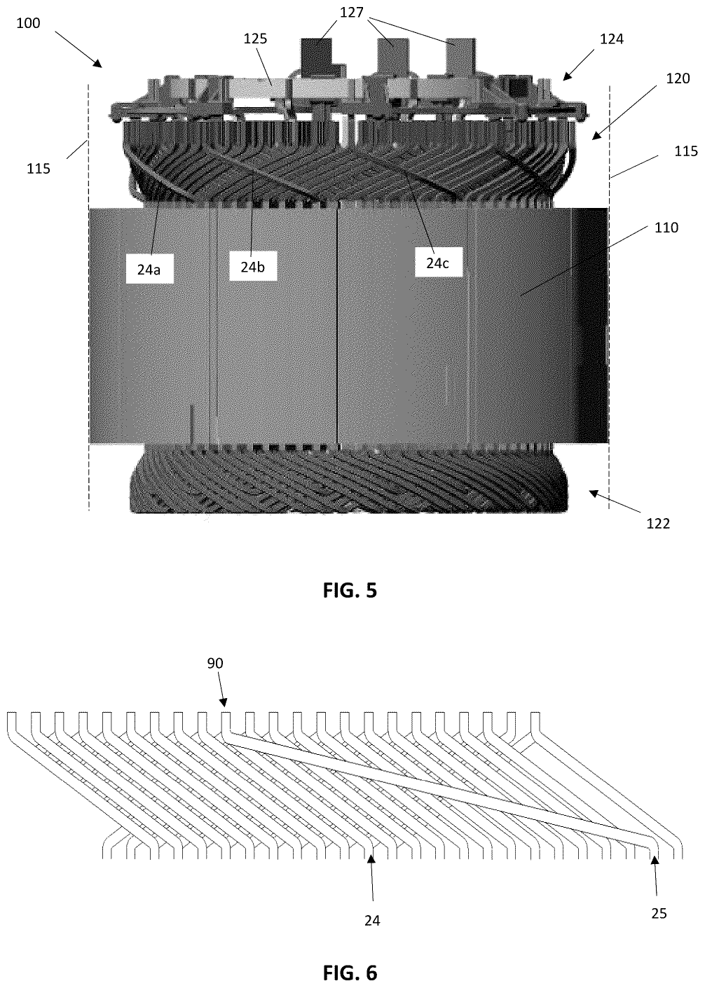

A first embodiment of the outer layer series connection between conductors 24 and 25 is illustrated in detail in FIG. 2 with respect to the C path. Although FIG. 2 particularly illustrates the C path connection between conductors 24 and 25, it will be recognized that the connection between conductors 24 and 25 for the A path and the B path are the same as that for the C path (but again, the A path and C path are arranged in different slots of the stator core). As used herein, the term “connection conductor” refers to one of the conductors 24, 25 that provides the connection between the first coil group (i.e., conductors 1-24) and the second coil group (i.e., conductors 25-48). As shown in FIG. 2, in one embodiment conductor 24 extends from layer 6, but is bent radially outward into an additional layer 7 at the weld end of the stator core. This additional layer 7 is referred to as an “extra-outer” layer because there is no equivalent layer within the slots where conductors reside, but is instead formed at a position that is radially outward from the conductors at the weld end, and axially outward from the core 110. In most embodiments, the extra-outer layer is also radially inward from a cylinder defined by the outer diameter of the core 110 (e.g., see cylinder 112 indicated by the dotted lines of FIG. 5). In other words, while the position of the extra-outer layer is radially outward from layer 6, it is typically confined radially within a cylindrical space defined by the outer wall of the stator core 110, with such cylindrical space extending to the axial and crown ends of the windings 120.

After being bent radially outward into the extra-outer layer 7, the conductor 24 (shown in FIG. 2 in association with the C path) is bent circumferentially some number of slots (e.g. six slots) to the right in the extra outer layer 7. It will be noted that the direction of this bend of conductor 24 (i.e., to the right) is opposite the direction of other conductors extending from layer 6 (i.e., to the left). Similarly, conductor 25 (which is again shown in FIG. 2 for the C path) extends from slot 68 of the core (which slot 68 is not shown in FIG. 2, but is shown in FIG. 1) is bent radially outward into another extra-outer layer 8 at the weld end of the stator core, and then bent some number of slots (e.g., six slots) to the left (i.e., toward the end of conductor 24). It will be noted that the direction of this twist of conductor 25 (i.e., to the left) is the same direction as other conductors extending from layer 6 (i.e., to the left). The ends of conductors 24 and 25 are then side-by side in layers 7 and 8 and are welded together to form a 12-pitch end turn at the weld end of the stator core.

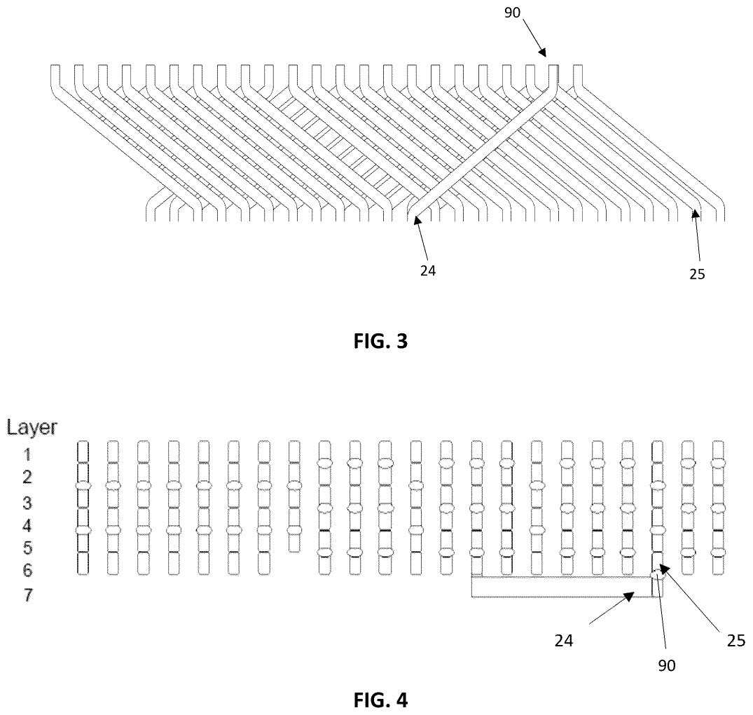

With reference now to FIGS. 3-5, in at least one embodiment, the extra-outer layer series connection between conductors 24 and 25 is formed by only bending conductor 24 to the right without bending conductor 25 in any different manner than other conductors in layer 6. In to the left just like all the wires in layer 6 (without bending the conductor into any additional layer). Conductor 24 is bent to layer 7 and twisted 6 slots to the right (i.e., opposite the twist direction of the other conductors in layer 6) and welded to conductor 25. In this embodiment no conductors are bent into an extra-outer layer 8 (i.e., this embodiment does not include the extra-outer layer 8 shown in FIG. 2). As shown in FIG. 3, conductor 24 is twisted in layer 7 in a direction opposite all of the other conductors of layer 6.

FIG. 4 shows that a connection 90 is made between conductors 24 and 25 radially outward from all of the other conductors in layers 5 and 6. This connection between conductors 24 and 25 is made at a position between layer 6 and extra-outer layer 7. This connection is provided by a weld (or heat stake or other connection) between the tips of the leg ends of conductors 24 and 25 that allows for a continuous electrical connection between conductors 24 and 25.

FIG. 5 shows a side view of a stator 100 and stator core 110 with the winding arrangement 120 arranged thereon. As discussed previously herein, the winding arrangement 120 includes a crown end 122 and a weld end 124. A busbar 125 and phase terminals 127 are positioned on the weld end 124 and act to complete the winding arrangement, as will be recognized by those of ordinary skill in the art. The core 110 is a generally cylindrical component comprised of a ferromagnetic material (e.g., a lamination stack of steel plates). The stator core 110 includes an inner diameter and an outer diameter with a cylindrical space defined within the outer diameter, as noted by dotted lines 115 in FIG. 5. Slots and teeth (not shown in FIG. 5) are formed between the inner and outer diameter of the core 110. The teeth extend radially inward to the inner diameter and the slots are formed between the teeth. The windings 120 are arranged in the slots of the core 110. A rotor (not shown) is arranged within the inner diameter of the core 110. Together the stator 100 and the rotor provide an electric machine. That may be used for any of various purposes (e.g., an electric drive for an automotive vehicle) as will be recognized by those of ordinary skill in the art.

It can be seen from FIG. 5 that the conductors providing the outer diameter series connections between two coil groups of each path (e.g., the conductors 24a, 24b and 24c) are bent into an extra-outer layer 7 that is radially outward from outer layer 6 and twisted in a direction opposite all of the other conductors of layer 6.

With reference now to FIG. 6, in at least one alternative embodiment, the outer layer series connection between conductors 24 and 25 is formed by bending conductor 25 into any extra-outer layer 7 and twisting it far to the left. In this embodiment, conductor 24 is twisted to the left just like all the wires in outer layer 6, and conductor 24 remains in layer 6 at the weld end of the stator core. However, conductor 25 is bent to an extra-outer layer 7 and is then twisted far to the left (i.e., 18 slots to the left). With this long 18-slot bend, the end of conductor 25 is positioned adjacent to the end of conductor 24 between layer 6 and extra-outer layer 7, and at this position the two conductors 24 and 25 are easily welded together to form the connection between two different coil groups of the winding path. Similar to the embodiment of FIGS. 3-5, no conductors need to be bent into layer 8 with the embodiment of FIG. 6.

Although the various embodiments have been provided herein, it will be appreciated by those of skill in the art that other implementations and adaptations are possible. For example, although the winding arrangement has been described herein as being formed from segmented conductors having leg ends welded together at one end, it would also be possible to form the winding from continuous portions of wire. As another example, while the winding arrangement has been described in association with a specific stator core and a specific winding, other stator cores and winding arrangements are contemplated, such as stator cores with fewer or more slots, windings having more or less than two coil groups per winding path. Additionally, it will be recognized that certain terms such as up, down, left, right, etc. are terms of convenience based on a particular orientation and viewpoint of the stator and that opposite or different terms may be used to describe the same embodiment of the stator, depending on perspective. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. An electric machine comprising:
a stator core; and
a plurality of windings wound on the stator core, wherein the plurality of windings include:
a first coil group arranged in a plurality of layers of the stator core;
a second coil group arranged in the plurality of layers of the stator core; and
at least one connection conductor between the first coil group and the second coil group provided in at least one extra-outer layer of the stator core.

2. The electric machine of claim 1 wherein the first coil group is arranged in a first and a second pole of the plurality of windings, and wherein the second coil group is arranged in the second and a third pole of the plurality of windings.

3. The electric machine of claim 2 wherein the first coil group includes a plurality of conductors forming laps of a first coil arranged in a first layer pair, and a plurality conductors forming of laps of a second coil arranged in a second layer pair.

4. The electric machine of claim 3 wherein the first coil is connected to the second coil via a connection between a conductor in the first layer pair and a conductor in the second layer pair.

5. The electric machine of claim 3 wherein the first coil group further includes a plurality of conductors forming laps of a third coil arranged in a third layer pair.

6. The electric machine of claim 1 wherein the at least one connection between the first coil group to the second coil group is arranged in a single extra-outer layer of the stator core.

7. The electric machine of claim 1 wherein the at least one connection between the first coil group to the second coil group is arranged in a plurality of extra-outer layers of the stator core.

8. The electric machine of claim 1 wherein the at least one connection between the first coil group to the second coil group is provided by at least one conductor leg end that extends from an outer layer of the stator core and is twisted into the extra-outer layer in an opposite direction from conductors in the outer layer.

9. The electric machine of claim 1 wherein the at least one connection between the first coil group and the second coil group is provided by at least one conductor leg end that extends from an outer layer of the stator core and is twisted into the extra-outer layer in a same direction as conductors in the outer layer.

10. The electric machine of claim 1 wherein the plurality of windings are comprised of a plurality of interconnected segmented conductors.

11. A stator comprising:
a cylindrical core defined by an inner diameter and an outer diameter with a plurality of teeth extending radially inward to the inner diameter and slots formed between the teeth;
a winding arrangement formed by plurality of segmented conductors arranged in the slots of the core, the plurality of segmented conductors positioned in layers within the slots and connected together on a connection end of the core that is opposite a crown end of the core, wherein the layers include an inner layer and an outer layer, wherein the connected segmented conductors form at least one first coil and at least one second coil on the core, and wherein the segmented conductors extending from the outer layer are twisted in a first direction on the connection end of the core; and
at least one connection conductor extending from the outer layer and bent to a position radially outward from the segmented conductors positioned in the outer layer of the core, wherein the at least one connection conductor connects the at least one first coil to the at least one second coil on the core.

12. The stator of claim 11 wherein the extra-outer layer is axially outward from the core and radially inward from the outer diameter.

13. The stator of claim 11 wherein the at least one first coil is associated with a first pair of poles of the winding arrangement and the at least one second coil is associated with a second pair of poles of the winding arrangement.

14. The stator of claim 11 wherein the at least one connection conductor is bent in an opposite direction from the segmented conductors positioned in the outer layer.

15. The stator of claim 11 wherein the at least one connection conductor is bent in a same direction as the segmented conductors positioned in the outer layer.

16. An electric machine comprising:
a plurality of lap windings positioned on a stator core, the plurality of lap windings including:
at least one first coil arranged between an inner conductor layer and an outer conductor layer of the stator core, the at least one first coil making multiple laps through slots of the stator core associated with a first pair of poles of the electric machine;
at least one second coil arranged between the inner conductor layer and the outer conductor layer of the stator core, the at least one second coil making multiple laps through slots of the stator core associated with a second pair of poles of the electric machine; and
at least one connecting conductor positioned in an extra-outer layer of the stator core and connecting the at least one first coil to the at least one second coil.

17. The electric machine of claim 16 wherein the at least one connecting conductor extends from the outer conductor layer on a connection end of the stator core.

18. The electric machine of claim 17 wherein the at least one connecting conductor is bent an opposite direction from other conductors extending from the outer conductor layer on the connection end of the stator core.

19. The electric machine of claim 17 wherein the at least one connecting conductor is bent a same direction as other conductors extending from the outer conductor layer on the connection end of the stator core.

20. The electric machine of claim 17 wherein the at least one first coil is one of three coils in a first coil group, wherein the at least one second coil is one of three coils in a second coil group, wherein the at least one connecting conductor provides a series connection between the first coil group and the second coil group, and wherein the first coil group and the second coil group form one of three phases of a winding arrangement for the electric machine.
